(19) United States
(12) Patent Application Publication
(10) Pub. No.: US 2018/0018362 A1
(43) Pub. Date: Jan. 18, 2018

(54) DATA PROCESSING METHOD AND DATA PROCESSING APPARATUS

(71) Applicant: FUJITSU LIMITED, Kawasaki-shi (JP)

(72) Inventors: Tatsuya Asai, Kawasaki (JP); TAKASHI KATOH, Yokohama (JP); Junichi Shigezumi, Kawasaki (JP); Hiroya INAKOSHI, Tama (JP); Yuiko OHTA, Kawasaki (JP)

(73) Assignee: FUJITSU LIMITED, Kawasaki-shi (JP)

(21) Appl. No.: 15/598,712

(22) Filed: May 18, 2017

(30) Foreign Application Priority Data
Jul. 13, 2016 (JP) 2016-138309

(51) Int. Cl. G06F 17/30

(52) U.S. Cl. CPC G06F 17/30371; G06F 17/30377; G06F 17/30498

(57) ABSTRACT

A data processing apparatus includes a processor. The processor selects candidate tables corresponding to a first table. The respective candidate tables include a first data item included in the first table. The processor acquires a first coincidence degree of the first table for the respective candidate tables. The processor selects third tables corresponding to one of the candidate tables. The respective third tables include a second data item included in the one of the candidate tables. The processor acquires a second coincidence degree of the one of the candidate tables for the respective third tables. The processor acquires a reliability of the one of the candidate tables on basis of the first coincidence degree of the first table for the one of the candidate tables and the second coincidence degree of the one of the candidate tables for the respective third tables.

### CROSS-REFERENCE TO RELATED APPLICATION

This application is based upon and claims the benefit of priority of the prior Japanese Patent Application No. 2016-138309, filed on Jul. 13, 2016, the entire contents of which are incorporated herein by reference.

### FIELD

The embodiments discussed herein are related to a data processing method and a data processing apparatus.

### BACKGROUND

In a large-scale system in a lot of organizations such as enterprises or government agencies, new master tables and old master tables may be mixed without being organized, and master tables that are divided for each area may be left unidentifiable. In this case, since it is difficult to select and join the master tables associated with transaction data, there is a problem that utilization of data is remarkably restricted.

A technology is known, which identifies data which meets a search condition of a search request, among data acquired through a search in each of management data repositories (MDRs), based on a priority of a combination of the MDRs acquired from the search request received from a client device.

Related technologies are disclosed in, for example, Japanese Laid-Open Patent Publication No. 2014-021704, Japanese Laid-Open Patent Publication No. 2006-189921, and Japanese Laid-Open Patent Publication No. 11-191115.

### SUMMARY

According to an aspect of the present invention, provided is a data processing apparatus including a memory and a processor coupled to the memory. The processor is configured to select candidate tables corresponding to a first table from among second tables. A record of the respective candidate tables includes a first data item included in a record of the first table. The processor is configured to acquire a first coincidence degree of the first table for the respective candidate tables. The first coincidence degree indicates a degree of coincidence between the first table and the respective candidate tables. The processor is configured to select third tables corresponding to one of the candidate tables from among the second tables. A record of the respective third tables includes a second data item included in a record of the one of the candidate tables. The processor is configured to acquire a second coincidence degree of the one of the candidate tables for the respective third tables. The second coincidence degree indicates a degree of coincidence between the one of the candidate tables and the respective third tables. The processor is configured to acquire a reliability of the one of the candidate tables on basis of the first coincidence degree of the first table for the one of the candidate tables and the second coincidence degree of the one of the candidate tables for the respective third tables. The processor is configured to output the acquired reliability.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a joining process;

FIG. 2 is a diagram illustrating an example of selecting a master on the basis of a joining success rate;

FIG. 3 is a diagram illustrating an exemplary hardware configuration of a data processing apparatus;

FIG. 4 is a diagram illustrating an exemplary functional configuration of a data processing apparatus according to a first embodiment;

FIG. 5 is a diagram illustrating an example of a joining chain in the first embodiment;

FIG. 6 is a diagram illustrating an exemplary calculation of reliability based on a joining rate according to the first embodiment;

FIG. 7 is a flowchart illustrating a flow of a joining-master selection process according to the first embodiment;

FIG. 8 is a flowchart illustrating a flow of a joining process of S20;

FIG. 9 is a flowchart illustrating a flow of a master search process of S40;

FIG. 10 is a flowchart illustrating a flow of S432;

FIG. 11 is a diagram illustrating an exemplary functional configuration of a data processing apparatus according to a second embodiment;

FIG. 12 is a diagram illustrating an example of a joining chain in the second embodiment;

FIG. 13 is a diagram illustrating an exemplary calculation of reliability based on a survival number according to the second embodiment;

FIG. 14 is a flowchart illustrating a flow of a joining-master selection process according to the second embodiment;

FIG. 15 is a flowchart illustrating a flow of a joining process of S20-2;

FIG. 16 is a flowchart illustrating a flow of a master search process of S40-2;

FIG. 17 is a flowchart illustrating a flow of S404-2; and

FIG. 18 is a diagram illustrating a third embodiment.

### DESCRIPTION OF EMBODIMENTS

In the conventional technology described above, since the same data managed with different names are given with a common name and managed as the same data, it is premised that correspondence of data is already known. Therefore, in the case where correspondence of data (correspondence of tables) is indefinite or unclear, there is a problem that a table such as an actuated transaction and a table such as a master which is accumulated and left may not correspond to each other.

Hereinafter, embodiments of the present disclosure will be described with reference to the accompanying drawings. In a large-scale system, when new and old masters are mixed without being organized, it may be difficult to select and join masters corresponding to transaction data of sales order, payment, a delivery, etc., with a business partner. In such a situation, there is a problem that the utilization of the data is remarkably restricted.

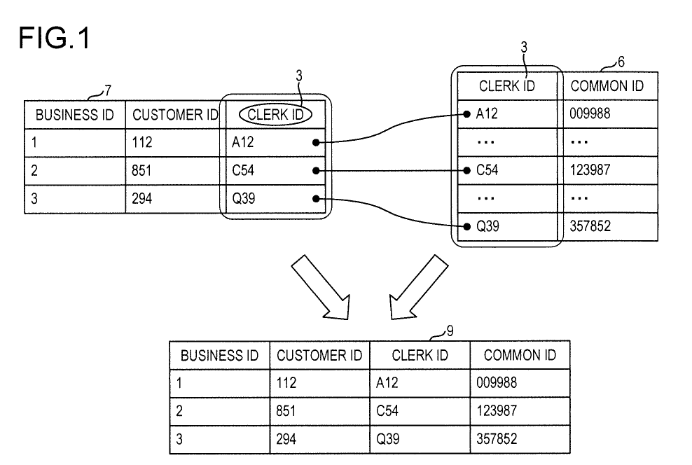

In the embodiments, a transaction (or transaction data) corresponds to table type data to which data is frequently added. A master (or master data) corresponds to table type data of which a frequency of update is low. There are many cases in which the master is used to register information (registration information of a customer, a clerk, a product, and the like) on the business. A joining process (or, a JOIN process) is a process of merging respective records of the transaction and the master having the same keyword in corresponding key items. The joining process will be described with reference to FIG. 1.

FIG. 1 is a diagram illustrating the joining process. In FIG. 1, a transaction 7 is a table having items including BUSINESS ID, CUSTOMER ID, CLERK ID, and the like. In an example illustrated in FIG. 1, a record of BUSINESS ID “1” includes CUSTOMER ID “112”, CLERK ID “A12”, and the like. A record of BUSINESS ID “2” includes CUSTOMER ID “851”, CLERK ID “C54”, and the like. A record of BUSINESS ID “3” includes CUSTOMER ID “294”, CLERK ID “Q39”, and the like.

A master 6 is a table having items including CLERK ID, COMMON ID, and the like. In an example illustrated in FIG. 1, a record of CLERK ID “A12” includes COMMON ID “009988”, and the like. A record of CLERK ID “C54” includes COMMON ID “123987”, and the like. A record of CLERK ID “Q39” includes COMMON ID “357852”, and the like.

When CLERK ID of the transaction 7 and the master 6 is a key item 3, records in which values of the key item 3 coincide with each other are joined (joining operation) and a joined table 9 is generated.

The joined table 9 has the items including BUSINESS ID, CUSTOMER ID, CLERK ID, COMMON ID, and the like. In an example illustrated in FIG. 1, a record of BUSINESS ID “1” includes CUSTOMER ID “112”, CLERK ID “A12”, COMMON ID “009988”, and the like. A record of the transaction 7 and a record of the master 6, both of which have the same CLERK ID “A12”, are joined to each other. And so too with records of BUSINESS ID “2” and BUSINESS ID “3”.

In FIG. 1, a case where one master corresponds to the key item 3 with respect to the transaction 7 is described, but two or more masters may correspond to the same key item 3 when the new and old masters are mixed. In the case where two or more masters exist, the most probable master is preferably selected as to correspond to the transaction 7.

The case where two masters (referred to as “candidate masters”) which may correspond to the transaction 7 exist is considered. It is considered that a master of which a joining success rate is highest with respect to the number of records of the transaction 7 is selected between the two candidate masters.

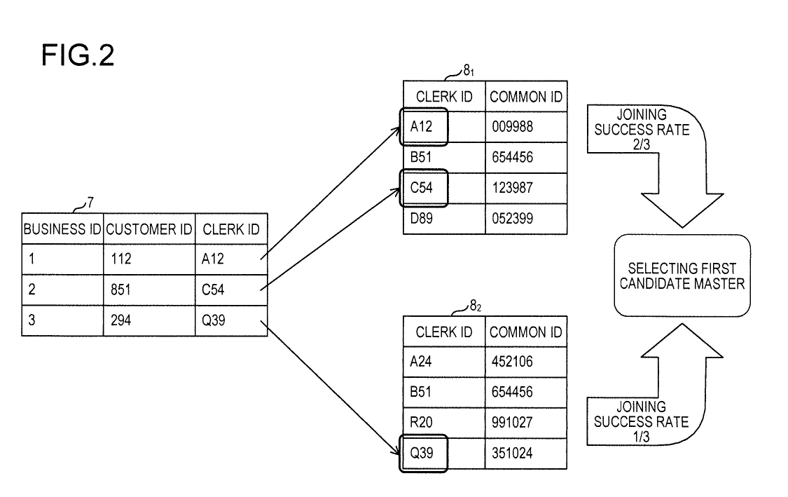

FIG. 2 is a diagram illustrating an example of selecting a master on the basis of a joining success rate. In FIG. 2, a case is illustrated where the candidate masters correspond to the records of the transaction 7 by CLERK ID include a first candidate master 8₁ and a second candidate master 8₂. Both the first candidate master 8₁ and the second candidate master 8₂ are masters having at least the item of CLERK ID.

In the first candidate master 8₁, a record of CLERK ID “A12” corresponds to the record of CLERK ID “A12” of the transaction 7. Further, a record of CLERK ID “C54” corresponds to the record of CLERK ID “C54” of the transaction 7.

However, since a record of CLERK ID “Q39” does not exist, the first candidate master 8₁ does not correspond to the record of CLERK ID “Q39” of the transaction 7. Therefore, two records correspond to three records of the transaction 7 and the joining success rate of the transaction 7 and the first candidate master 8₁ is “⅔”.

In the second candidate master 8₂, a record of CLERK ID “Q39” corresponds to the record of CLERK ID “Q39” of the transaction 7. However, since the records of CLERK ID “A12” and “C54” do not exist, the second candidate master 8₂ does not correspond to any of the records of CLERK ID “A12” and “C54” of the transaction 7. Therefore, one record corresponds to the three records of the transaction 7 and the joining success rate of the transaction 7 and the second candidate master 8₂ is “⅓”.

Since the joining success rate of the first candidate master 8₁ is higher than the joining success rate of the second candidate master 8₂, the first candidate master 8₁ is selected as the master corresponding to the transaction 7 in the case of selection based on the joining success rate.

However, a general database management system (DBMS) is designed so as to join and use several masters in a chain. Therefore, although the joining success rate (also referred to as “joining rate”) of the transaction 7 and a master such as the first candidate master 8₁ is just high, it may not be said that the transaction 7 and the first candidate master 8₁ probably correspond to each other.

That is, another master proficiently joined to a candidate master, which may be joined to the transaction 7, may be searched for and an extent of an influence range in which the transaction 7 and the corresponding masters may be joined in a chain may be quantified. The quantification of the extent of the influence range, in which the transaction 7 and the corresponding masters may be joined in a chain, enables selection of the candidate master which is more probable as a master to be joined to the transaction 7. Based on such a viewpoint, steps given below are proposed by the inventors.

(First Step) Enumerate candidate masters joinable to the transaction 7, and calculate respective joining rates thereof.

(Second Step) Check whether each of the candidate masters is joinable to respective masters on the DBMS, and calculate the respective joining rate of the candidate masters joinable to masters on the DBMS.

(Third Step) Repeat the Second Step recursively with respect to the masters acquired in the Second Step until the joining rate is equal to or less than a threshold value.

(Fourth Step) Quantify the extent of the influence range of each joining chain of the respective candidate masters by calculating a product (alternatively, a mean) of the joining rates of the joins in the joining chain.

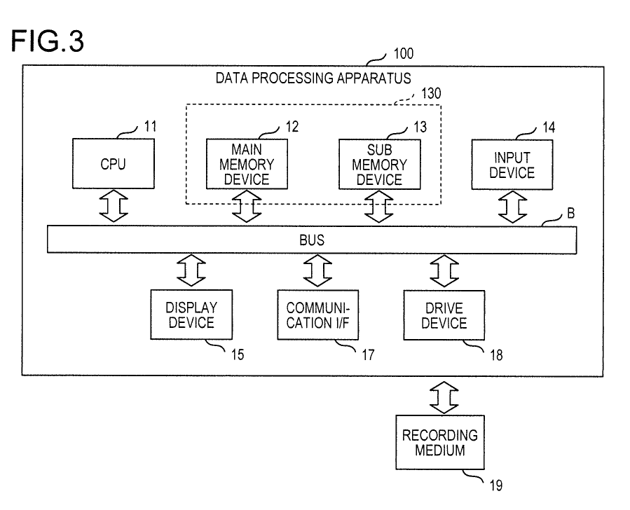

A data processing apparatus 100 that quantifies the extent of the influence range of each joining chain has a hardware configuration illustrated in FIG. 3.

FIG. 3 is a diagram illustrating an exemplary hardware configuration of a data processing apparatus. In FIG. 3, the data processing apparatus 100 is an information processing apparatus controlled by a computer, and includes a central processing unit (CPU) 11, a main memory device 12, a sub memory device 13, an input device 14, a display device 15, a communication interface (I/F) 17, and a drive device 18. Each component is coupled to a bus B.

The CPU 11 corresponds to a processor that controls the data processing apparatus 100 in accordance with a program stored in the main memory device 12. As for the main memory device 12, a random access memory (RAM), a read-only memory (ROM), and the like are used, and the main memory device 12 stores or temporarily conserves therein the program executed by the CPU 11, data required for processing in the CPU 11, data acquired through the processing in the CPU 11, and the like.

As for the sub memory device 13, a hard disk drive (HDD) and the like are used, and the sub memory device 13 stores therein data including a program for executing various processing and the like. As a portion of the program stored in the sub memory device 13 are loaded to the main memory device 12 and executed by the CPU 11, various processing is implemented.

The input device 14 includes a mouse, a keyboard, and the like and is used for a user to input various information required for the processing by the data processing apparatus 100. The display device 15 displays various types of information required under the control of the CPU 11. The input device 14 and the display device 15 may be a user interface configured by an integrated touch panel and the like. The communication I/F 17 performs communication through a wired or wireless network. The communication by the communication I/F 17 is not limited to the wired or wireless network.

The program that implements the processing performed by the data processing apparatus 100 is provided to the data processing apparatus 100 by a recording medium 19 including, for example, a compact disc ROM (CD-ROM).

The drive device 18 performs an interface between the recording medium 19 (e.g., a CD-ROM) set in the drive device 18 and the data processing apparatus 100.

The program for implementing various processing according to the embodiment to be described below is stored in the recording medium 19, and the program stored in the recording medium 19 is installed in the data processing apparatus 100 via the drive device 18. The installed program becomes executable by the data processing apparatus 100.

The recording medium 19 storing the program is not limited to the CD-ROM and may be one or more non-transitory computer-readable tangible media having a structure. The computer-readable recording media may include portable recording media including a digital versatile disk (DVD), a universal serial bus (USB) memory, and the like and semiconductor memories including a flash memory and the like in addition to the CD-ROM.

### First Embodiment

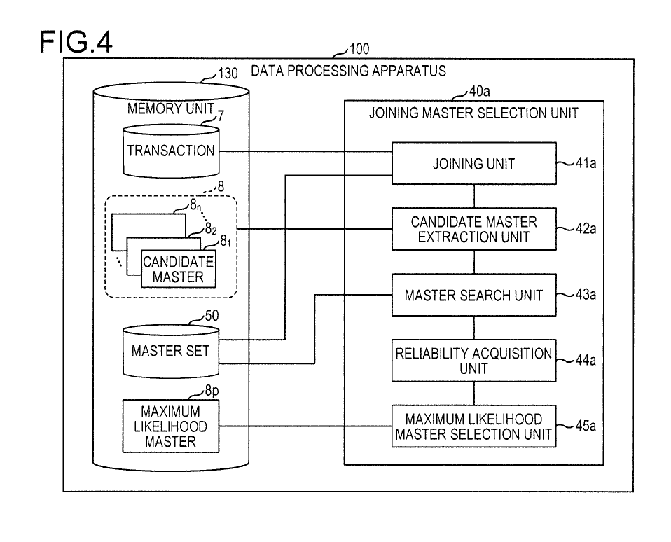

A first embodiment in which the extent of the influence range of the joining chain is quantified by a product of the joining rates will be described. FIG. 4 is a diagram illustrating an exemplary functional configuration of a data processing apparatus according to the first embodiment.

In FIG. 4, the data processing apparatus 100 includes a joining master selection unit 40a and a memory unit 130. The joining master selection unit 40a is implemented when the program installed in the data processing apparatus 100 is executed by the CPU 11 of the data processing apparatus 100. The memory unit 130 stores therein the transaction 7, a master set 50, candidate masters 8₁, 8₂, . . . , 8ₙ (collectively referred to as “candidate masters 8”), a maximum likelihood master 8p, and the like.

The joining master selection unit 40a is a processing unit that selects the maximum likelihood master 8p which is most probable as the master joined to the transaction 7 by the key item 3 from among the master set 50, and includes a joining unit 41a, a candidate master extraction unit 42a, a master search unit 43a, a reliability acquisition unit 44a, and a maximum likelihood master selection unit 45a.

The joining unit 41a receives the transaction 7 and calculates the joining rate of the transaction 7 with respect to respective masters in the master set 50. The joining unit 41a calculates a ratio of the number of records joined to a master with respect to the total number of records of the transaction 7 to acquire the joining rate.

The candidate master extraction unit 42a extracts a plurality of candidate masters 8 on the basis of the joining rate calculated by the joining unit 41a. A predetermined number of candidate masters may be selected in an order of higher joining rate to be set as the candidate masters 8. Alternatively, masters having a joining rate of a predetermined threshold value or more may be selected to be set as the candidate masters 8. The joining unit 41a and the candidate master extraction unit 42a correspond to a first coincidence degree acquisition unit.

The master search unit 43a searches for a master which is joinable to each candidate master 8 by coincidence of the value of the item, and a next master which is further joinable to the joinable master by the coincidence of the value of the item, that is, searches for the masters recursively joinable in a joining chain from each candidate master 8, and acquires the joining rates between the masters. The master search unit 43a corresponds to a second coincidence acquisition unit.

The reliability acquisition unit 44a multiplies the joining rates along the joining chain to calculate a reliability indicating a probability of correspondence of the transaction 7 and each of the candidate masters 8. The maximum likelihood master selection unit 45a selects, as the maximum likelihood master 8p, a candidate master 8 having the highest reliability among the reliabilities calculated by the reliability acquisition unit 44a.

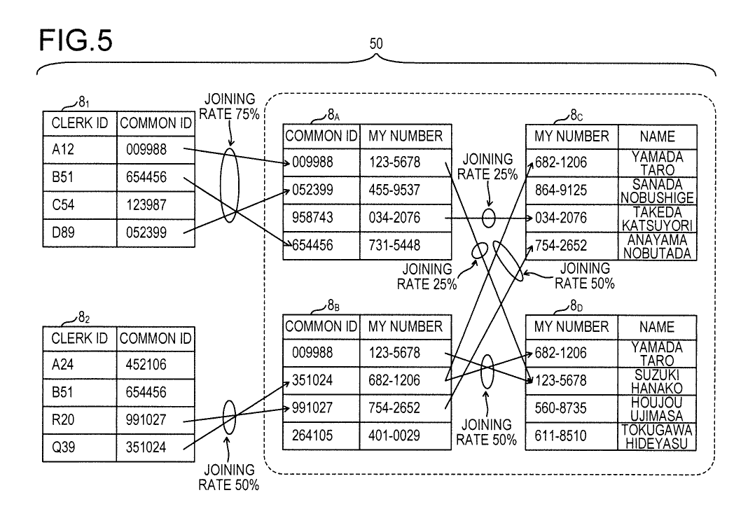

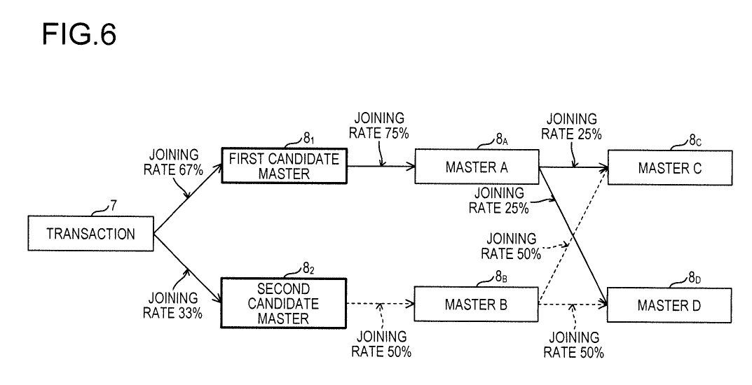

The joining chain and the joining rate in the first embodiment will be described with reference to FIGS. 5 and 6. FIG. 5 is a diagram illustrating an example of joining chain in the first embodiment. FIG. 5 is continued from FIG. 2, and illustrates the joining chain of each of the first candidate master 8₁ and the second candidate master 8₂.

It is determined that the first candidate master 8₁ may be joined to master 8_{A} (master A) by coincidence of the value of COMMON ID. Three records may be joined to the master 8_{A} from the first candidate master 8₁. The coincidence values of COMMON ID are “009988”, “654456”, and “052399”. Three records are joined among “4” which is the total number of records of the first candidate master 8₁, and as a result, the joining rate is “75%”.

The master 8_{A} may be joined to the master 8_{D} (master D) by coincidence of the value of MY NUMBER. One record is joined to the master 8_{D} from the master 8_{A} and the value of MY NUMBER is “123-5678”. One record is joined among “4” which is the total number of records of the master 8_{A}, and as a result, the joining rate is “25%”.

The master 8_{A} may be joined to the master 8_{C} (master C) by the coincidence of the value of MY NUMBER. One record is joined to the master 8_{C} from the master 8_{A} and the value of MY NUMBER is “034-2076”. One record is joined among “4” which is the total number of records of the master 8_{A}, and as a result, the joining rate is “25%”.

Meanwhile, the second candidate master 8₂ may be joined to master 8_{B} (master B) by the coincidence of the value of COMMON ID. Two records may be joined to the master 8_{B} from the second candidate master 8₂ and the values of COMMON ID are “991027” and “351024”. Two records are joined among “4” which is the total number of records of the second candidate master 8₂, and as a result, the joining rate is “50%”.

The master 8_{B} may be joined to the master 8_{D} by the coincidence of the value of MY NUMBER. Two records are joined to the master 8_{D} from the master 8_{B} and the values of MY NUMBER are “123-5678” and “682-1206”. Two records are joined among “4” which is the total number of records of the master 8_{B}, and as a result, the joining rate is “50%”.

The master 8_{B} may be joined to the master 8_{C} by the coincidence of the value of MY NUMBER. Two records are joined to the master 8_{C} from the master 8_{B} and the values of MY NUMBER are “682-1206” and “754-2652”. Two records are joined among “4” which is the total number of records of the master 8_{B}, and as a result, the joining rate is “50%”.

FIG. 6 is a diagram illustrating an exemplary calculation of reliability based on a joining rate according to the first embodiment. The exemplary calculation of the reliability for selecting a candidate master 8, which is most probably joined from the transaction 7, will be described with reference to FIG. 6.

In the joining chains from the transaction 7, the joining rate to the first candidate master 8₁ from the transaction 7 is ⅔=67% as illustrated in FIG. 2. As illustrated in FIG. 5, the joining rate to the master 8_{A} from the first candidate master 8₁ is 75%, the joining rate to the master 8_{C} from the master 8_{A} is 25%, and the joining rate to the master 8_{D} from the master 8_{A} is 25%.

Therefore, from the joining rates, the reliability of the joining to the first candidate master 8₁ from the transaction 7 is 67%×75%×25%×25%=3.1%.

The joining rate to the second candidate master 8₂ from the transaction 7 is ⅓=33% as illustrated in FIG. 2. As illustrated in FIG. 5, the joining rate to the master 8_{B} from the second candidate master 8₂ is 50%, the joining rate to the master 8_{C} from the master 8_{B} is 50%, and the joining rate to the master 8_{D} from the master 8_{B} is 50%.

Therefore, from the joining rates, the reliability of the joining to the second candidate master 8₂ from the transaction 7 is 33%×50%×50%×50%=4.1%.

With respect to the reliability of “3.1%” of the first candidate master 8₁, the reliability of the second candidate master 8₂ is “4.1%” which is higher than the reliability of the first candidate master 8₁. Therefore, it is determined that joining the transaction 7 to the second candidate master 8₂ is more probable. Thus, the maximum likelihood master 8p indicating the second candidate master 8₂ is output to the memory unit 130. The maximum likelihood master 8p may be displayed in the display device 15.

According to the first embodiment, the probability of the joining is not determined only by the joining rate of the master which is directly connected to the transaction 7, and a plurality of masters successively joined from the transaction 7 are included to enhance the precision of the probability of the correspondence of the transaction 7 to the master on the basis of the probability of the joining chain as a whole.

That is, the first candidate master 8₁ is selected in the example of FIG. 2, while the second candidate master 8₂ is selected in the first embodiment. By selecting the second candidate master 8₂, more items may be precisely joined from the plurality of masters as a result of the joining operation by correspondence with a higher probability.

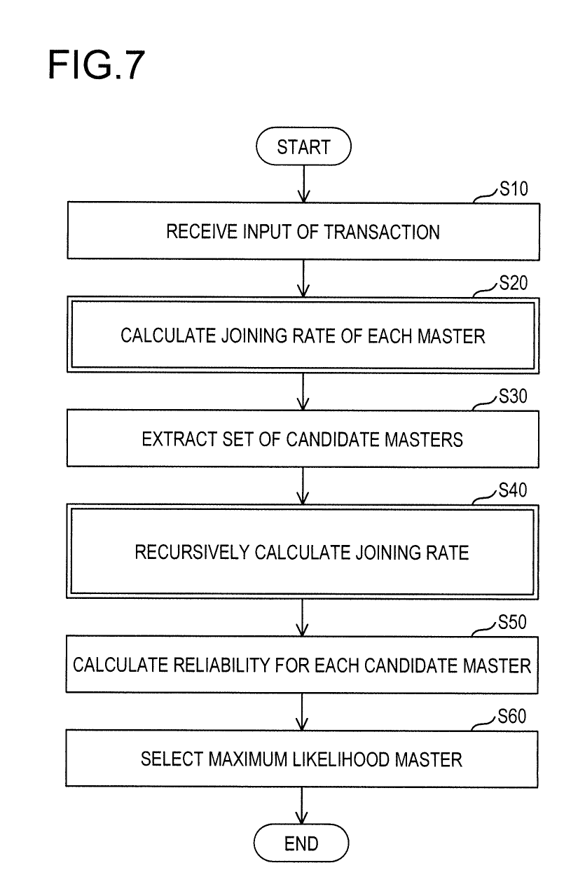

Next, a joining-master selection process of selecting the maximum likelihood master 8p performed by the joining master selection unit 40a by using the joining rates in the first embodiment will be described. FIG. 7 is a flowchart illustrating a flow of the joining-master selection process according to the first embodiment.

Referring to FIG. 7, in the joining master selection unit 40a, when the joining unit 41a receives an input of the transaction 7 (S10), the joining unit 41a joins respective masters in the master set 50 with the transaction 7 and calculates a joining rate for each master (S20). The joining unit 41a calculates the ratio of the number of records joined to the master with respect to the total number of records of the transaction 7.

The candidate master extraction unit 42a extracts a set of the candidate masters 8 from the master set 50 on the basis of the joining rate indicating the probability of the correspondence of the transaction 7 and the master (S30).

The master search unit 43a recursively calculates a joining rate with respect to the joinable master for each candidate master 8 (S40).

The reliability acquisition unit 44a calculates a reliability by multiplying the joining rates of masters along the joining chain for each candidate master 8 (S50). The maximum likelihood master selection unit 45a selects a candidate master 8 having the highest reliability as the maximum likelihood master 8p (S60). The maximum likelihood master 8p is stored in the memory unit 130. The maximum likelihood master 8p may be displayed in the display device 15. The joining master selection unit 40a ends the joining-master selection process according to the first embodiment.

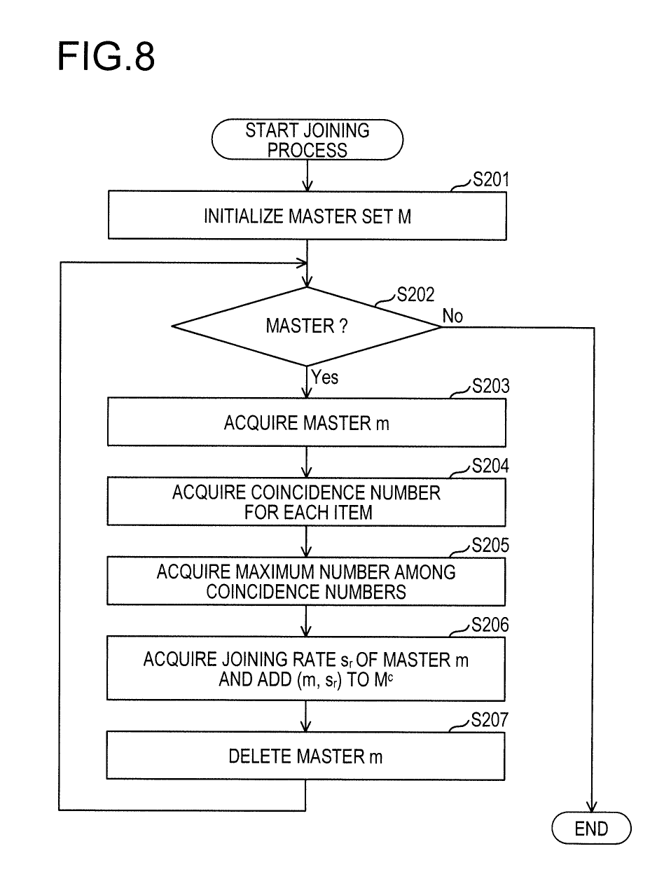

The joining process of acquiring the joining rate for selecting a candidate master 8 which may be joined to the transaction 7 performed by the joining unit 41a in S20 will be described. FIG. 8 is a flowchart illustrating a flow of the joining process of S20.

In FIG. 8, the master set 50 stored in the memory unit 130 is represented by a master set M, and one master selected from the master set M is referred to as a master m. Further, an identifier identifying the master m and the acquired joining rate sᵣ are represented by (m, sᵣ), and a set having (m, sᵣ) as an element is represented by a candidate decision master set M^{c}. The candidate decision master set M^{c} is referred for deciding a candidate master 8 to be joined from the transaction 7.

The joining unit 41a initializes the master set M with the master set 50 stored in the memory unit 130 (S201). The joining unit 41a determines whether any masters exist in the master set M (S202). When it is determined that some masters exist (“Yes” of S202), the joining unit 41a acquires one master m from the master set M (S203).

The joining unit 41a acquires, for each of the same items between the transaction 7 and the master m, the number (hereinafter, referred to as “coincidence number”) of values which coincide with each other between the transaction 7 and the master m (S204), and acquires the maximum number c among the coincidence numbers acquired for the same items (S205).

The joining unit 41a acquires the joining rate sᵣ of the master m on the basis of the total number of records of the transaction 7 and the maximum number c and adds (m, sᵣ) to the candidate decision master set M^{c} (S206) and thereafter, deletes the maser m from the master set M (S207), and returns to S202 to repeat the processing as described above.

When it is determined that no master exists in the master set M (“No” of S202), the joining unit 41a ends the joining process.

The candidate master extraction unit 42a acquires all (m, sᵣ), in which the joining rate sᵣ is not zero, from the candidate decision master set M^{c} which is the result of the joining process performed by the joining unit 41a. The candidate master extraction unit 42a may acquire a predetermined number of (m, sᵣ) in an order of higher joining rate sᵣ or acquire (m, sᵣ) in which the joining rate sᵣ is equal to or more than a threshold value. The masters m corresponding to the acquired plurality of (m, sᵣ) are stored in the memory unit 130 as the candidate masters 8.

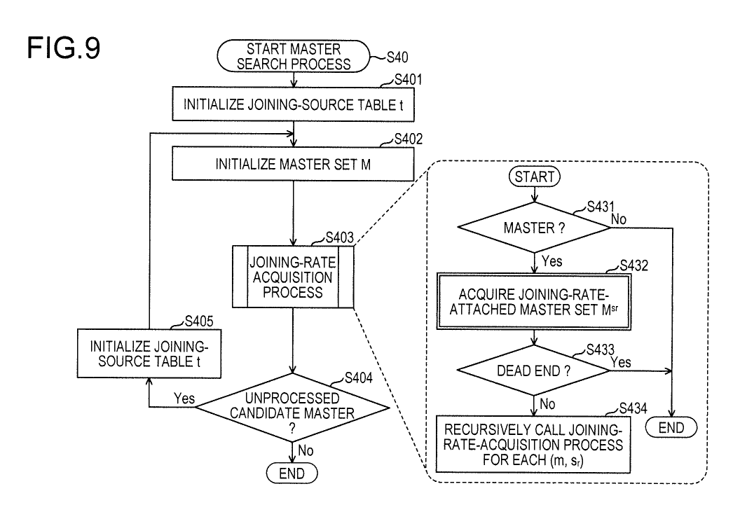

Next, a master search process performed by the master search unit 43a in S40 will be described. FIG. 9 is a flowchart illustrating a flow of the master search process of S40.

In FIG. 9, a candidate master 8 as the master at the joining source is represented by a joining-source table t. The plurality of masters other than the candidate master 8 is represented by a master set M, and one master selected from the master set M is referred to as a master m. Further, the master m and the acquired joining rate sᵣ are represented by (m, sᵣ), and a set having (m, sᵣ) as an element is represented by a joining-rate-attached maser set M^{Sr}. That is, M^{Sr}={(m, sᵣ)|mεM, sᵣεR}. Where R represents a set of real numbers.

The master search unit 43a initializes the joining-source table t with one of the candidate masters 8 (S401). Further, the master search unit 43a initializes the master set M with the master set 50 stored in the memory unit 130 other than the one of the candidate masters 8 (S402).

The master search unit 43a performs a joining-rate acquisition process of acquiring a joining rate sᵣ of each master m in a joining chain from the joining-source table t (S403). In the joining-rate acquisition process, the master search unit 43a determines whether any masters exist in the master set M (S431). When it is determined that no master exists (“No” of S431), the master search unit 43a ends the joining-rate acquisition process.

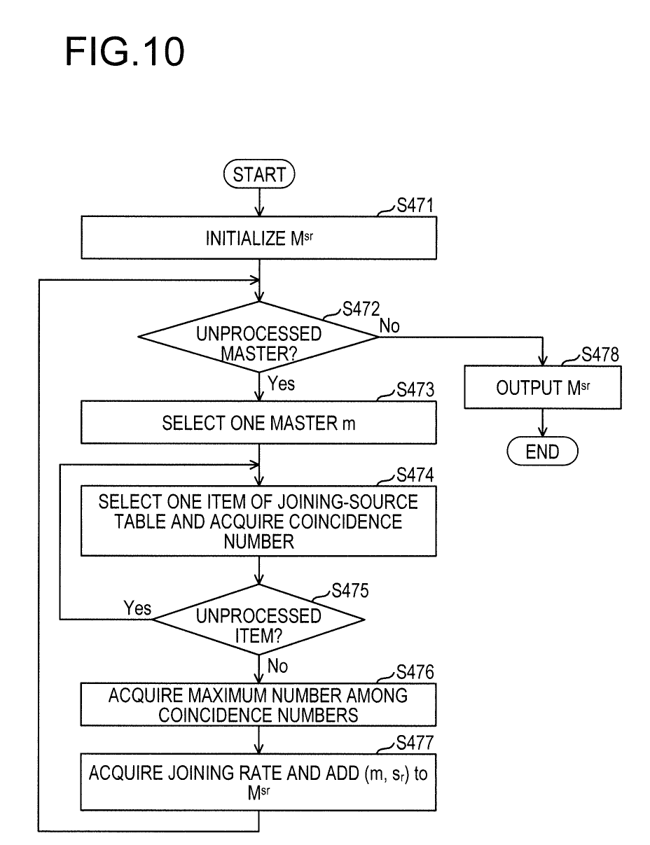

When it is determined that some masters exist (“Yes” of S431), the master search unit 43a acquires a joining-rate-attached maser set M^{Sr} including an element (m, sᵣ) in which the joining rate sᵣ of the joining-source table t for each master m of the master set M is associated with the master m (S432). The processing of acquiring the joining-rate-attached maser set M^{Sr} will be described in detail with reference to FIG. 10.

The master search unit 43a determines whether a dead end is reached. That is, it is determined whether the joining rate sᵣ is zero in all masters m of the acquired joining-rate-attached maser set M^{Sr} (S433). When it is determined that the dead end is not reached (No of S433), the master search unit 43a initializes the joining-source table t with the master m for each (m, sᵣ), in which the joining rate sᵣ is not zero, initializes the master set M with the master set 50 other than the master m, and recursively calls the joining-rate acquisition process (S434).

When it is determined that the dead end is reached (“Yes” of S433), the master search unit 43a ends the joining-rate acquisition process. When the master search unit 43a returns from the joining-rate acquisition process, the master search unit 43a determines whether any unprocessed candidate masters 8 remain (S404).

When it is determined that some unprocessed candidate master 8 remain (Yes of S404), the master search unit 43a initializes the joining-source table t with the next candidate master 8 (S405) and returns to S402 to repeat the processing as described above. When it is determined that no unprocessed candidate master 8 remains (“No” of S404), the master search unit 43a ends the master search process.

FIG. 10 is a flowchart illustrating a flow of S432 of FIG. 9. In FIG. 10, the master search unit 43a receives the joining-source table t and initializes the joining-rate-attached maser set M^{Sr} with a null set φ (S471).

The master search unit 43a determines whether any unprocessed masters exist in the master set M (S472). When it is determined that some unprocessed masters exist in the master set M (“Yes” of S472), the master search unit 43a selects one master m from the master set M (S473). In the processing of S401 (or S405), the joining-source table t is initialized with one candidate master 8.

The master search unit 43a selects one item of the joining-source table t and acquires, for the selected item, a coincidence number between the joining-source table t and the master m selected in S473 (S474). The master search unit 43a determines whether any unprocessed items of the joining-source table t exist (S475). When it is determined that some unprocessed items of the joining-source table t exist (“Yes” of S475), the master search unit 43a repeats the processing of S474.

When it is determined that no unprocessed item of the joining-source table t exists (“No” of S475), the master search unit 43a acquires the maximum number c among the coincidence numbers acquired with respect to all items (S476).

The master search unit 43a acquires the joining rate sᵣ on the basis of the total number of records of the joining-source table t and the maximum number c and adds (m, sᵣ) to the joining-rate-attached maser set M^{Sr} (S477). Thereafter, the master search unit 43a returns to S472 to repeat the processing as described above.

When it is determined that no master exists in the master set M (“No” of S472), the master search unit 43a outputs the joining-rate-attached maser set M^{Sr} (S478).

According to the first embodiment, the joining rates sᵣ acquired along a joining chain which starts from the transaction 7 are multiplied for each candidate master 8 to obtain the reliability indicating the probability that the candidate master will be joined to the transaction 7, and the candidate master 8 having the highest reliability is determined as the maximum likelihood master 8p for which the joining probability from the transaction 7 is highest. Instead of multiplying the joining rates sᵣ, the reliability may be acquired by a weighted sum, a mean value, and the like.

### Second Embodiment

In a second embodiment, the reliability is acquired on the basis of a survival number indicating the number of survival records which survive in a joining chain which starts from the transaction 7. The survival number corresponds to the number of records of each master, which contribute to join to a master at a terminal in a joining chain in which the records of the masters are successively joined by the coincidence of the values of an item.

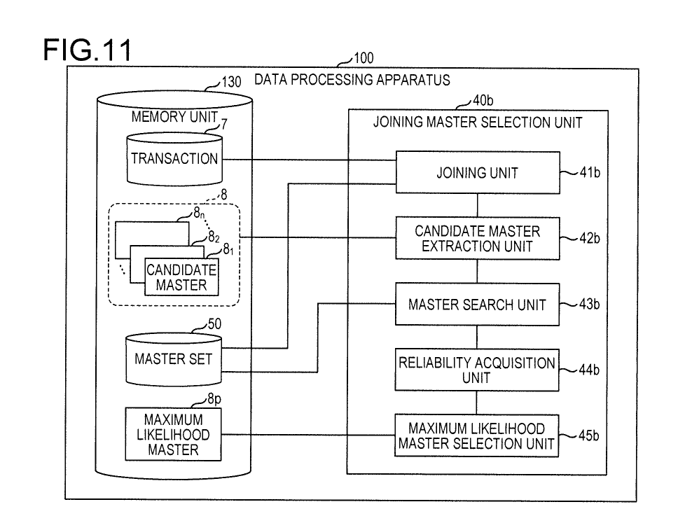

FIG. 11 is a diagram illustrating an exemplary functional configuration of a data processing apparatus according to the second embodiment. In FIG. 11, a data processing apparatus 100 according to the second embodiment includes a joining master selection unit 40b and the memory unit 130. The joining master selection unit 40b is implemented when a program installed in the data processing apparatus 100 is executed by the CPU 11 of the data processing apparatus 100. The transaction 7, the master set 50, the plurality of candidate masters 8, the maximum likelihood master 8p, and the like are stored in the memory unit 130 similarly to the first embodiment.

The joining master selection unit 40b is a processing unit that selects the maximum likelihood master 8p which is most probable as the master joined to the transaction 7 by the key item 3 from the master set 50 and includes a joining unit 41b, a candidate master extraction unit 42b, a master search unit 43b, a reliability acquisition unit 44b, and a maximum likelihood master selection unit 45b.

The joining unit 41b receives the transaction 7 and calculates the number (hereinafter, referred to as “the number of joined records”) of records which may be joined to the transaction 7 with respect to respective masters in the master set 50.

The candidate master extraction unit 42b extracts a plurality of candidate masters 8 on the basis of the number of joined records, which is calculated by the joining unit 41b. A predetermined number of candidate masters may be selected in an order of higher number of joined records to be set as the candidate masters 8. Alternatively, masters having one or more (or a predetermined threshold value or more) joined records may be selected to be set as the candidate masters 8.

The master search unit 43b searches for a master which is joinable to each candidate master 8 by coincidence of the value of the item, and a next master which is further joinable to the joinable master by the coincidence of the value of the item, that is, searches for the masters recursively joinable in a joining chain from each candidate master 8, and thereafter, acquires the number of records which contribute to join to a master at a terminal for each master to acquire the number of survival records of each master.

The reliability acquisition unit 44b sums up the number of survival records along the joining chain to calculate a reliability indicating a probability of correspondence of the transaction 7 and the candidate master 8. The maximum likelihood master selection unit 45b selects, as the maximum likelihood master 8p, a candidate master 8 having the highest reliability among the reliabilities calculated by the reliability acquisition unit 44b.

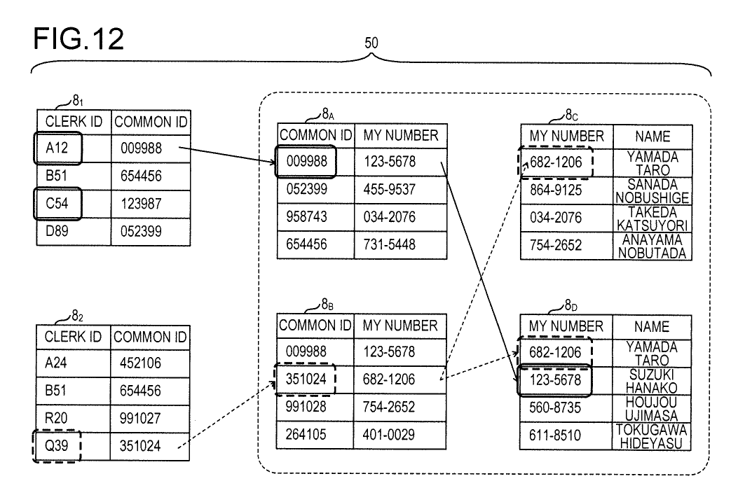

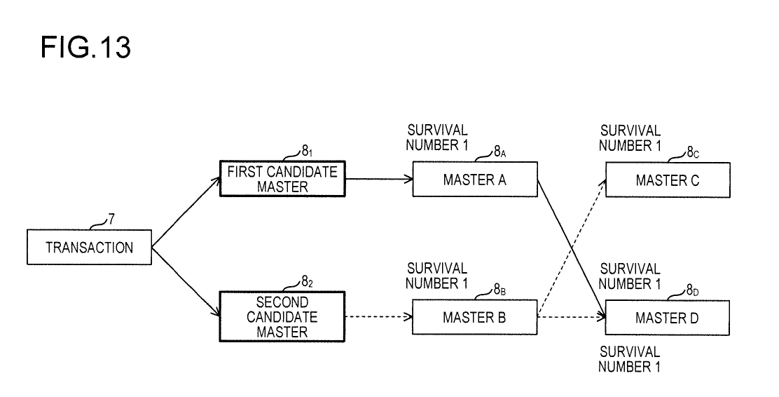

The joining chain and the survival number in the second embodiment will be described with reference to FIGS. 12 and 13. FIG. 12 is a diagram illustrating an example of a joining chain in the second embodiment. FIG. 12 is continued from FIG. 2, and illustrates, the joining chain of each of the first candidate master 8₁ and the second candidate master 8₂.

The first candidate master 8₁ may be joined to records of the master 8_{A} and further, the joined records of the master 8_{A} may be joined to records of the master 8_{D}, by the coincidence of the values of an item.

Three records may be joined to the master 8_{A} from the first candidate master 8₁, by the coincidence of the value of COMMON ID. The coincidence values in COMMON ID are “009988”, “654456”, and “052399”.

However, records of the master 8_{A} which contribute to join to the records of the master 8_{D}, which become the terminals of the joining chains from the first candidate master 8₁, include only one record in which the value of COMMON ID is “009988”. Thus, “1” is given to the survival number of the master 8_{A}.

The record of the master 8_{A}, in which the value of COMMON ID is “009988”, may be joined to the master 8_{D} by the coincidence of the value of MY NUMBER. One record is joined to the master 8_{D} from the master 8_{A} and the value of MY NUMBER is “123-5678”. The survival number of the master 8_{D}, which is the terminal of the joining chain from the first candidate master 8₁, is “1”.

Meanwhile, the second candidate master 8₂ may be joined to the master 8_{B} by the coincidence of the value of COMMON ID. Two records may be joined to the master 8_{B} from the second candidate master 8₂ and the values of COMMON ID are “991027” and “351024”.

However, records of the master 8_{B} which contribute to join to the records of at least one of the master 8_{C} and the master 8_{D}, which become the terminals of the joining chains from the second candidate master 8₂, include only one record in which the value of COMMON ID is “351024”. Thus, “1” is given to the survival number of the master 8_{B}.

The record of the master 8_{B}, in which the value of COMMON ID is “351024”, may be joined to the master 8_{C} and the master 8_{D} by the coincidence of the value of MY NUMBER. One record of the master 8_{B} may be joined to the master 8_{C} and the master 8_{D} by coincidence of “682-1206” which is the value of MY NUMBER. The survival number of each of the master 8_{C} and the master 8_{D}, each of which is the terminal of the joining chain from the second candidate master 8₂, is “1”.

As such, according to the second embodiment, the survival number is given to masters starting from the master 8_{A} joined from the first candidate master 81 and similarly, the survival number is given to masters starting from the master 8_{B} joined from the second candidate master 8₂. The survival numbers of the respective masters which may be joined from each candidate master 8 in a chain are summed up to calculate the reliability for the candidate master 8. The candidate master 8 having the highest reliability becomes the maximum likelihood master 8p.

FIG. 13 is a diagram illustrating an exemplary calculation of the reliability based on the survival number according to the second embodiment. With reference to FIG. 13, the exemplary calculation of the reliability for selecting a candidate master 8 (maximum likelihood master 8p) which is the most probable, which corresponds to the transaction 7 will be described.

In the joining chains from the transaction 7, the survival number of the master 8_{A} joined from the first candidate master 81 is “1”, and the survival number of the master 8_{D} is “1”. Therefore, based on these survival numbers, the reliability of the joining to the first candidate master 81 from the transaction 7 is 1+1=2.

The survival number of the master 8_{B} joined from the second candidate master 82 is “1”, the survival number of the master 8_{C} is “1”, and further, the survival number of the master 8_{D} is “1”. Therefore, based on these survival numbers, the reliability of the joining to the second candidate master 82 from the transaction 7 is 1+1+1=3.

With respect to the reliability of “2” of the first candidate master 8₁, the reliability of the second candidate master 8₂ is “3” which is higher than the first candidate master 8₁. Therefore, it is determined that joining the transaction 7 to the second candidate master 8₂ is more probable. Thus, the maximum likelihood master 8p indicating the second candidate master 8₂ is output to the memory unit 130. The maximum likelihood master 8p may be displayed in the display device 15.

According to the second embodiment, the probability of the joining is not determined only by the number of joined records of the master which is directly joined from the transaction 7, and a plurality of masters successively joined from the transaction 7 are included to enhance the precision of the probability of the correspondence of the transaction 7 to the master on the basis of the probability of the joining chain as a whole.

That is, the first candidate master 8₁ is selected in the example of FIG. 2, while the second candidate master 8₂ is selected in the second embodiment. By selecting the second candidate master 8₂, more items may be precisely joined from the plurality of masters as a result of the joining operation by correspondence with a higher probability.

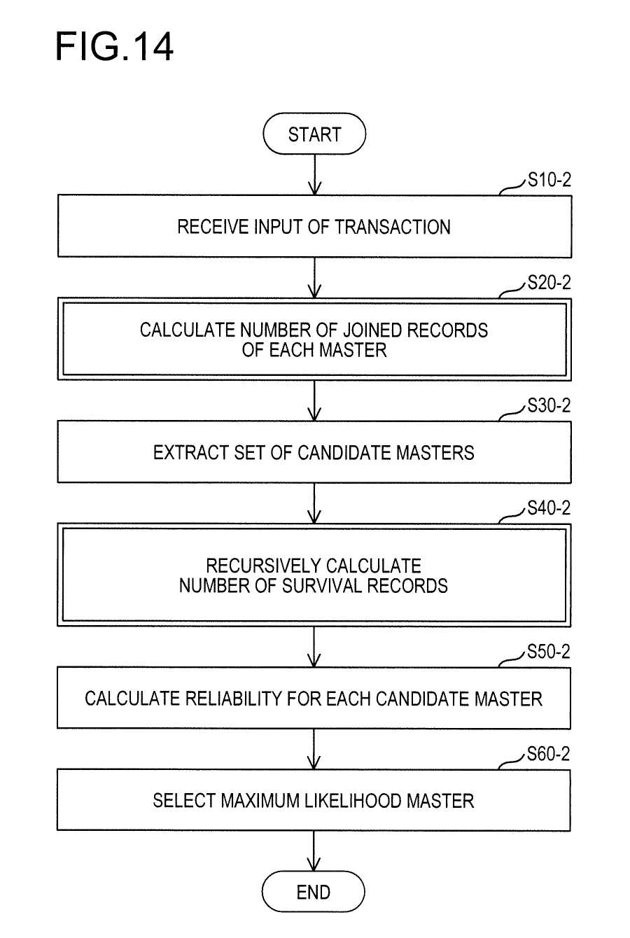

Next, the joining-master selection process of selecting the maximum likelihood master 8p performed by the joining master selection unit 40b by using the survival number in the second embodiment will be described. FIG. 14 is a flowchart illustrating a flow of the joining-master selection process according to the second embodiment.

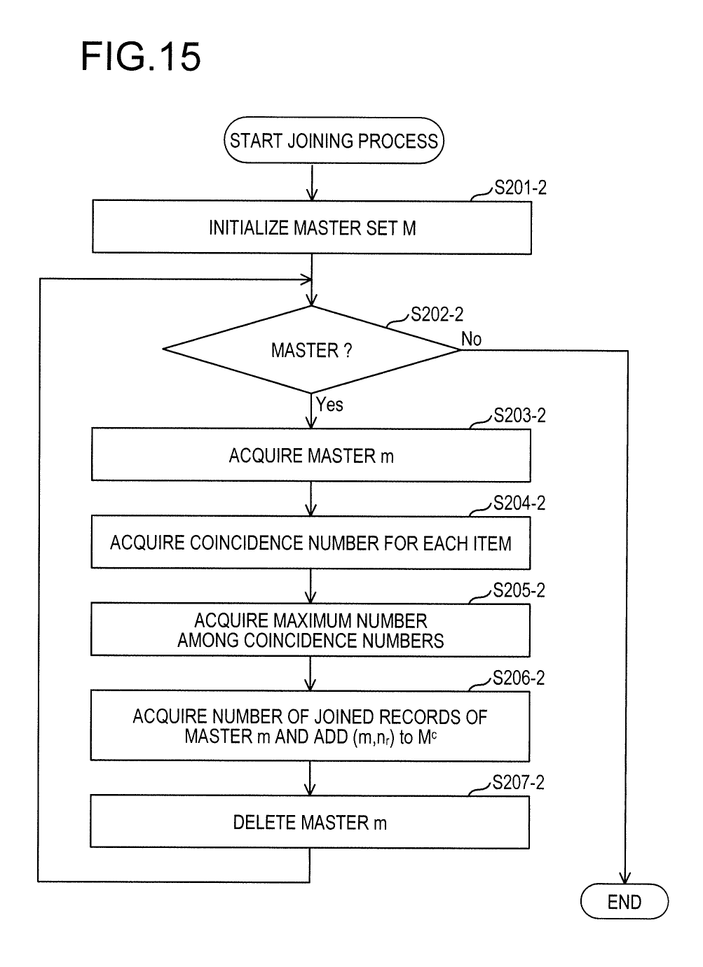

Referring to FIG. 14, in the joining master selection unit 40b, when the joining unit 41b receives an input of the transaction 7 (S10-2), the joining unit 41b joins respective masters in the master set 50 with the transaction 7 and calculates the number of joined records which may be joined to the transaction 7 for each master (S20-2). The joining process by the joining unit 41b will be described in detail in FIG. 15.

The candidate master extraction unit 42b extracts a set of the candidate masters 8 from the master set 50 on the basis of the number of joined records, which is calculated in S20-2 (S30-2).

The candidate master extraction unit 42b may determine, as the candidate master 8, a master in which the number of joined records is 1 or more (a threshold value or more) based on the number of joined records of each master in the master set 50.

The master search unit 43b recursively calculates a survival number for the joinable master for each candidate master 8 to acquire the survival number of each master in the joining chain (S40-2).

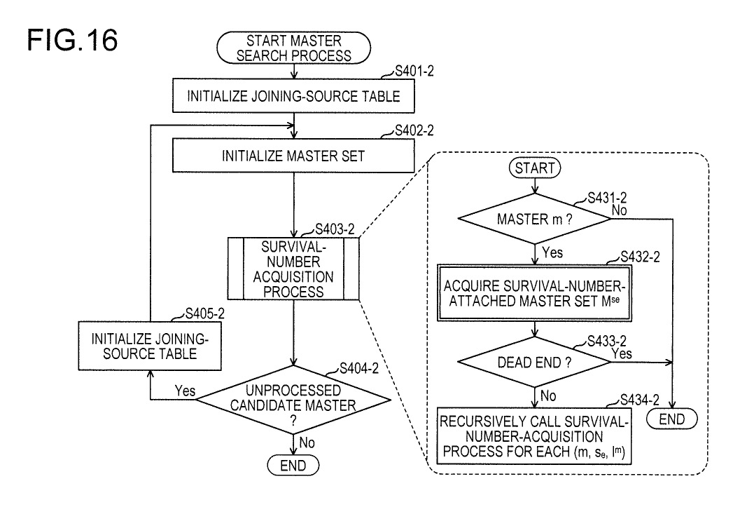

The master search unit 43b recursively calculates the number of joined records for the joinable master for each candidate master 8 to determine a joining chain of the candidate master 8 and acquire the survival number of each master and the candidate master 8 by ascending from the master at the terminal of the determined joining chain. The master search unit 43b memorizes the identifier and the survival number of the respective masters. The master search process by the master search unit 43b will be described in detail in FIG. 16.

The reliability acquisition unit 44b calculates a reliability by summing up the numbers of survival records of the masters along the joining chain for each candidate master 8 (S50-2). The maximum likelihood master selection unit 45b selects the maximum likelihood master 8p having the highest reliability among the candidate masters 8 and stores the selected maximum likelihood master 8p in the memory unit 130 on the basis of the reliabilities acquired by the reliability acquisition unit 44b (S60-2). The maximum likelihood master selection unit 45b may display the maximum likelihood master 8p in the display device 15. Thereafter, the joining master selection unit 40b ends the joining-master selection process according to the second embodiment.

The joining process of acquiring the number of joined records for selecting the candidate master 8 which may be joined to the transaction 7 performed by the joining unit 41b of S20-2 will be described. FIG. 15 is a flowchart illustrating a flow of the joining process of S20-2.

In FIG. 15, the master set 50 stored in the memory unit 130 is represented by a master set M, and one master selected from the master set M is referred to as a master m. Further, an identifier identifying the master m and the acquired number nᵣ of joined records are represented by (m, nᵣ), and a set having (m, nᵣ) as an element is represented by a candidate decision master set M^{c}. The candidate decision master set M^{c} is referred for deciding a candidate master 8 to be joined from the transaction 7.

The joining unit 41b initializes the master set M with the master set 50 stored in the memory unit 130 (S201-2). The joining unit 41b determines whether any masters exist in the master set M (S202-2). When it is determined that some masters exist (“Yes” of S202-2), the joining unit 41b acquires one master m from the master set M (S203-2).

The joining unit 41b acquires a coincidence number for each of the same items between the transaction 7 and the master m (S204-2), and acquires the maximum number c among the coincidence numbers acquired for the same items (S205-2).

The joining unit 41b acquires the number nᵣ of joined records of the master m on the basis of the total number of records of the transaction 7 and the maximum number c and adds (m, nᵣ) to the candidate decision master set M^{c} (S206-2) and thereafter, deletes the maser m from the master set M (S207-2) and returns to S202-2 to repeat the processing as described above.

When it is determined that no master exists in the master set M (“No” of S202-2), the joining unit 41b ends the joining process.

The candidate master extraction unit 42b acquires all (m, nᵣ), in which the number nᵣ of joined records is not zero, from the candidate decision master set M^{c} which is the result of the joining process performed by the joining unit 41b. The candidate master extraction unit 42b may acquire a predetermined number of (m, nᵣ) in an order of higher number nᵣ of joined records or acquire (m, nᵣ) in which the number nᵣ of joined records is equal to or more than a threshold value. The master m corresponding to the acquired plurality of (m, nᵣ) are stored in the memory unit 130 as the candidate masters 8.

Next, a master search process performed by the master search unit 43b in S40-2 will be described. FIG. 16 is a flowchart illustrating a flow of the master search process of S40-2.

In FIG. 16, a candidate master 8 as the master at the joining source is represented by a joining-source table t. The plurality of masters other than the candidate master 8 is represented by a master set M, and one master selected from the master set M is referred to as a master m. Further, the master m, the acquired survival number sₑ, and a survival list l^{m} of m are represented by (m, sₑ, l^{m}). The survival list l^{m} is a list of IDs of the joined records. A set having (m, sₑ, l^{m}) as an element is represented by a survival-number-attached master set M^{se}. That is, M^{se}={(m, sₑ, l^{m})|mεM, sₑεN, l^{m} represents a survival list of m}, where, N is a set of natural numbers.

The master search unit 43b initializes the joining-source table t with one of the candidate masters 8 (S401-2). Further, the master search unit 43b initializes the master set M with the master set 50 stored in the memory unit 130 other than the one of the candidate masters 8 (S402-2).

The master search unit 43b performs a survival number acquisition process of acquiring a survival number sₑ of each master m in a joining chain from the joining-source table t (S403-2). In the survival number acquisition process, the master search unit 43b determines whether any masters exist in the master set M (S431-2). When it is determined that no master exists (“No” of S431-2), the master search unit 43b ends the survival number acquisition process.

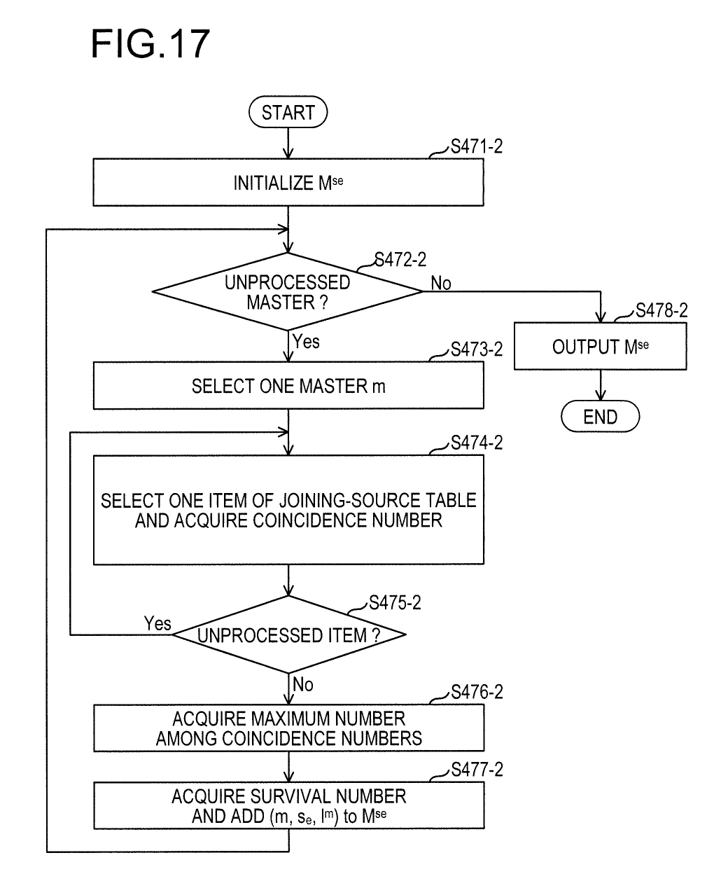

When it is determined that some masters exist (“Yes” of S431-2), the master search unit 43b acquires a survival-number-attached master set M^{se} including an element (m, sₑ, l^{m}) in which the survival number sₑ for the joining-source table t is associated with each master m of the master set M (S432-2). The processing of acquiring survival-number-attached master set M^{se} will be described in detail with reference to FIG. 17.

The master search unit 43b determines whether a dead end is reached. That is, it is determined whether the survival number sₑ is zero in all masters m of the acquired survival-number-attached master set M^{se} (S433-2). When it is determined that the dead end is not reached (“No” of S433-2), the master search unit 43b initializes the joining-source table t with the master m for each (m, sₑ, l^{m}), in which the survival number sₑ is not zero, initializes the master set M with the master set 50 other than the master m, and recursively calls the survival number acquisition process (S434-2).

When it is determined that the dead end is reached (“Yes” of S433-2), the master search unit 43b ends the survival number acquisition process. When the master search unit 43b returns from the survival number acquisition process, the master search unit 43b determines whether any unprocessed candidate masters 8 remain (S404-2).

When it is determined that some unprocessed candidate master 8 remain (“Yes” of S404-2), the master search unit 43b initializes the joining-source table t with the next candidate master 8 (S405-2) and returns to S402-2 to repeat the processing as described above. When it is determined that no unprocessed candidate master 8 remains (“No” of S404-2), the master search unit 43b ends the master search process.

FIG. 17 is a flowchart illustrating a flow of S432-2 of FIG. 16. In FIG. 17, the master search unit 43b receives the joining-source table t and initializes the survival-number-attached master set M^{se} with a null set φ (S471-2).

The master search unit 43b determines whether any unprocessed masters exist in the master set M (S472-2). When it is determined that some unprocessed masters exist in the master set M (“Yes” of S472-2), the master search unit 43b selects one master m from the master set M (S473-2). In the processing of S401-2 (or S405-2), the joining-source table t is initialized with one candidate master 8.

The master search unit 43b selects one item of the joining-source table t and acquires, for the selected item, the coincidence number between survival records of the joining-source table t and the master m selected in S473-2. The survival records of the joining-source table t are indicated by a survival list l of joining-source table t. The master search unit 43b adds record IDs of records of the master m, which have the coincided item value, to a survival list l of the master m (S474-2). The master search unit 43b determines whether any unprocessed items of the joining-source table t exist (S475-2). When it is determined that some unprocessed items of the joining-source table t exist (“Yes” of S475-2), the master search unit 43b repeats the processing of S474-2.

When it is determined that no unprocessed item of the joining-source table t exists (“No” of S475-2), the master search unit 43b acquires the maximum number c among the coincidence numbers acquired with respect to all items (S476-2).

The master search unit 43b determines survival list lm which is the survival list l including the maximum number c of record IDs and adds (m, sₑ, l^{m}) to the survival-number-attached master set M^{se} (S477-2). Thereafter, the master search unit 43b returns to S472-2 and to repeat the processing as described above.

When it is determined that no master exists in the master set M (“No” of S472-2), the master search unit 43b outputs the survival-number-attached master set M^{se} (S478-2).

According to the second embodiment, the survival numbers sₑ acquired along a joining chain which starts from the transaction 7 are added for each candidate master 8 to obtain the reliability indicating the probability that the candidate master will be joined to the transaction 7, and the candidate master 8 having the highest reliability is determined as the maximum likelihood master 8p for which the joining probability from the transaction 7 is highest.

According to the first and second embodiments, the maximum likelihood master 8p, which has the highest probability to be joined to one transaction 7, may be precisely selected. Next, a third embodiment of selecting a maximum likelihood master 8p, which has the highest probability to be joined to all of two or more transactions 7, will be described.

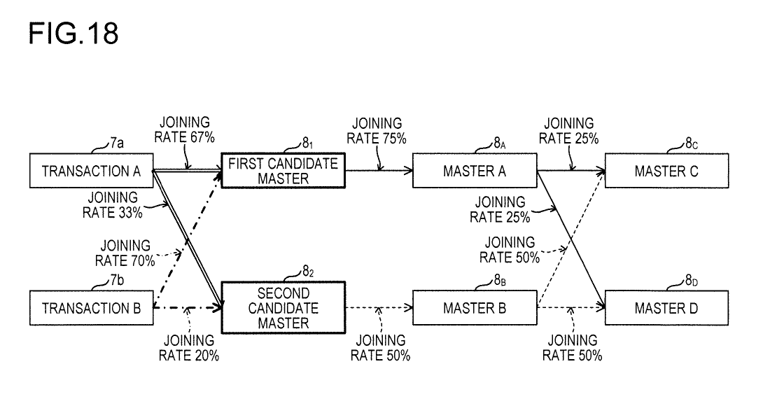

FIG. 18 is a diagram illustrating the third embodiment. According to the third embodiment, the maximum likelihood master 8p is acquired by using the joining rate with respect to each of a transaction 7a (transaction A) and a transaction 7b (transaction B) and a master having the highest reliability between two maximum likelihood masters 8p is decided as the maximum likelihood master 8p for both the transaction 7a and the transaction 7b.

The reliability of the first candidate master 8₁ which may be joined to the transaction 7a is 67%×75%×25%×25%=3.1%, therefore, 3.1%.

The reliability of the second candidate master 8₂ which may be joined to the transaction 7a is 33%×50%×50%×50%=4.1%, therefore, 4.1%.

The reliability of the first candidate master 8₁ which may be joined to the transaction 7b is 70%×75%×25%×25%=3.3%, therefore, 3.3%.

The reliability of the second candidate master 8₂ which may be joined to the transaction 7b is 20%×50%×50%×50%=2.5%, therefore, 2.5%.

Thus, the second candidate master 8₂ is determined to be the maximum likelihood master 8p for the transaction 7a, and the first candidate master 8₁ is determined to be the maximum likelihood master 8p for the transaction 7b.

The reliability of the second candidate master 8₂ which is the maximum likelihood master 8p for the transaction 7a is “4.1%” and the reliability of the first candidate master 8₁ which is the maximum likelihood master 8p for the transaction 7b is “3.3%”. Therefore, the second candidate master 8₂ having the higher reliability is selected as the maximum likelihood master 8p which may be joined to two transactions 7a and 7b.

As described above, according to the first, second, and third embodiments, even in a DBMS designed to join and use a plurality of masters in a chain, a master which is the highest in correspondence probability to the transaction 7 among the plurality of candidate masters may be selected with respect to a given transaction 7.

According to the first, second, and third embodiments, the precision of the probability of the correspondence of a transaction and a master may be increased, as compared with the selection of the maximum likelihood master 8p only based on a joining rate of a single master with the transaction 7.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
selecting candidate tables corresponding to a first table from among second tables, a record of the respective candidate tables including a first data item included in a record of the first table;
acquiring a first coincidence degree of the first table for the respective candidate tables, the first coincidence degree indicating a degree of coincidence between the first table and the respective candidate tables;
selecting third tables corresponding to one of the candidate tables from among the second tables, a record of the respective third tables including a second data item included in a record of the one of the candidate tables;
acquiring a second coincidence degree of the one of the candidate tables for the respective third tables, the second coincidence degree indicating a degree of coincidence between the one of the candidate tables and the respective third tables;
acquiring a reliability of the one of the candidate tables on basis of the first coincidence degree of the first table for the one of the candidate tables and the second coincidence degree of the one of the candidate tables for the respective third tables; and
outputting the acquired reliability.

2. The non-transitory computer-readable recording medium according to claim 1, the process comprising:
acquiring the first coincidence degree of the first table for the respective candidate tables by calculating a ratio of a number of first records of the first table with respect to a total number of records of the first table, the first data item included in the respective first records having a same value as a value of the first data item included in a record of the relevant candidate table.

3. The non-transitory computer-readable recording medium according to claim 1, the process comprising:
acquiring the second coincidence degree of the one of the candidate tables for the respective third tables by calculating a ratio of a number of second records of the one of the candidate tables with respect to a total number of records of the one of the candidate tables, the second data item included in the respective second records having a same value as a value of the second data item included in a record of the relevant third table.

4. The non-transitory computer-readable recording medium according to claim 1, the process comprising:
acquiring the reliability of the one of the candidate tables by multiplying or adding the first coincidence degree of the first table for the one of the candidate tables and the second coincidence degree of the one of the candidate tables for the respective third tables.

5. The non-transitory computer-readable recording medium according to claim 1, the process comprising:
acquiring the reliability of the respective candidate tables;
determining a maximum likelihood table for the first table from among the candidate tables, the maximum likelihood table having a highest reliability among the candidate tables; and
outputting the maximum likelihood table.

6. The non-transitory computer-readable recording medium according to claim 5, the process comprising:
determining maximum likelihood tables for respective fourth tables by setting the respective fourth tables as the first table;
selecting a first maximum likelihood table from among the maximum likelihood tables, the first maximum likelihood table having a highest reliability among the maximum likelihood tables; and
outputting the first maximum likelihood table.

7. A data processing method, comprising:
selecting, by a computer, candidate tables corresponding to a first table from among second tables, a record of the respective candidate tables including a first data item included in a record of the first table;
acquiring a first coincidence degree of the first table for the respective candidate tables, the first coincidence degree indicating a degree of coincidence between the first table and the respective candidate tables;
selecting third tables corresponding to one of the candidate tables from among the second tables, a record of the respective third tables including a second data item included in a record of the one of the candidate tables;
acquiring a second coincidence degree of the one of the candidate tables for the respective third tables, the second coincidence degree indicating a degree of coincidence between the one of the candidate tables and the respective third tables;
acquiring a reliability of the one of the candidate tables on basis of the first coincidence degree of the first table for the one of the candidate tables and the second coincidence degree of the one of the candidate tables for the respective third tables; and
outputting the acquired reliability.

8. A data processing apparatus, comprising:
a memory; and
a processor coupled to the memory and the processor configured to:
select candidate tables corresponding to a first table from among second tables, a record of the respective candidate tables including a first data item included in a record of the first table;
acquire a first coincidence degree of the first table for the respective candidate tables, the first coincidence degree indicating a degree of coincidence between the first table and the respective candidate tables;
select third tables corresponding to one of the candidate tables from among the second tables, a record of the respective third tables including a second data item included in a record of the one of the candidate tables;
acquire a second coincidence degree of the one of the candidate tables for the respective third tables, the second coincidence degree indicating a degree of coincidence between the one of the candidate tables and the respective third tables;
acquire a reliability of the one of the candidate tables on basis of the first coincidence degree of the first table for the one of the candidate tables and the second coincidence degree of the one of the candidate tables for the respective third tables; and
output the acquired reliability.
